(19) United States
(12) Patent Application Publication
(10) Pub. No.: US 2010/0052848 A1
(43) Pub. Date: Mar. 4, 2010

(54) REMOTE VEHICLE OPERATING SYSTEM

(75) Inventor: Owen Thunes, Sacramento, CA (US)

Correspondence Address: GLOBAL IP COUNSELORS, LLP, 1233 20TH STREET, NW, SUITE 700, WASHINGTON, DC, 20036-2680, US

(73) Assignee: NISSAN TECHNICAL CENTER NORTH AMERICA, INC., Farmington Hills, MI (US)

(21) Appl. No.: 12/198,371

(22) Filed: Aug. 26, 2008

(51) Int. Cl. G05B 19/00

(52) U.S. Cl. 340/5.64

(57) ABSTRACT

A remote vehicle operating system is provided that basically comprises a vehicle and a portable hand held electronic terminal for remotely operating the vehicle. The vehicle includes a vehicle exterior body, an onboard terminal and at least one onboard device operatively connected to the onboard terminal. The portable hand held electronic terminal includes a miniature vehicle shaped casing with a transmitter that communicates with the onboard terminal of the vehicle to transmit a command to the onboard device. In accordance with one aspect, an operating element is disposed on the casing in a position of the casing such that touching a miniature vehicle component corresponding to the vehicle component of the vehicle results in the operation of the vehicle component. In accordance with one aspect, the miniature vehicle shaped casing corresponds in general appearance to the vehicle exterior body of the vehicle.

### BACKGROUND OF THE INVENTION

1. Field of the Invention

The present invention generally relates to a remote vehicle operating system. More specifically, the present invention relates to a remote vehicle operating system that aids the user in identifying the users' key fob and/or operating various components of the user's vehicle.

2. Background Information

Many vehicles are provided with a key fob or remote control device for locking or unlocking doors. Currently, some uses intelligent-key in many vehicles to replace the traditional vehicle key and key fob functions. The intelligent-key has buttons to unlock/lock doors, trunk, etc., just as the remote keyless entry systems have used since the early 1990s. However, intelligent-key also includes an embedded transmitter to communicate with the vehicle, which allows a higher level of vehicle security as it can not be started unless the intelligent-key is communicating with the vehicle's body control module. Further, the intelligent-key is convenient for customers, as they don't actually need to insert a key in the ignition to start the vehicle; instead, they just need to have it inside the car, and the car will recognize the key and allow it to be started.

However, the intelligent-key usually has a generic shape and configuration. That is, all models of vehicles by a vehicle manufacturer typically have intelligent-key that look identical. In other words, there's no way to differentiate the appropriate intelligent-key for a vehicle if there is more than one vehicle in a household from the same manufacturer, unless the keys were on unique key chains or with some other way to differentiate them. Thus, the members of the household may be confused as to which key fob belongs to which vehicle.

Additionally, most key fobs have very generic button configurations. Thus, typically, there is no direct intuitive connection between a button's location and its function. In other words, the driver may not be able to quickly determine which button is used for which function.

In view of the above, it will be apparent to those skilled in the art from this disclosure that there exists a need for an improved remote vehicle operating system. This invention addresses this need in the art as well as other needs, which will become apparent to those skilled in the art from this disclosure.

### SUMMARY OF THE INVENTION

One object of the present invention is to provide a portable hand held electronic terminal that can be easily associated with the appropriate vehicle.

Another object of the present invention is to provide a portable hand held electronic terminal that provides a direct intuitive connection between a button's location and its function.

In accordance with one aspect of the present invention, a remote vehicle operating system is provided that basically comprises a vehicle and a portable hand held electronic terminal for remotely operating the vehicle. The vehicle includes a vehicle exterior body, an onboard terminal and at least one onboard device operatively connected to the onboard terminal. The portable hand held electronic terminal includes a miniature vehicle shaped casing corresponding in general appearance to the vehicle exterior body of the vehicle, but reduced in size with respect to the vehicle exterior body of the vehicle. The portable hand held electronic terminal further including a transmitter disposed in the miniature vehicle shaped casing that communicates with the onboard terminal of the vehicle to transmit a command to the onboard device.

In accordance with another aspect of the present invention, a remote vehicle operating system is provided that basically comprises a vehicle and a portable hand held electronic terminal for remotely operating the vehicle. The vehicle includes a vehicle exterior body, an onboard terminal and at least one onboard device operatively connected to the onboard terminal to perform a selected operation of a vehicle component. The portable hand held electronic terminal includes a miniature vehicle shaped casing. The portable hand held electronic terminal further includes a transmitter disposed in the miniature vehicle shaped casing that communicates with the onboard terminal of the vehicle to transmit a command to the onboard device. The portable hand held electronic terminal further includes an operating element disposed in a position of the miniature vehicle shaped casing such that touching a miniature vehicle component corresponding to the vehicle component of the vehicle results in the operation of the vehicle component.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view of a remote vehicle operating system having a vehicle and a portable hand held electronic terminal in accordance with one embodiment;

FIG. 2 is a top plan view of the vehicle illustrated in FIG. 1;

FIG. 3 is a simplified schematic view of selected component of the vehicle illustrated in FIGS. 1 and 2 that are associated with the portable hand held electronic terminal;

FIG. 4 is a side elevational view of the portable hand held electronic terminal (e.g., key fob) illustrated in FIG. 1;

FIG. 5 is a rear elevational view of the portable hand held electronic terminal (e.g., key fob) illustrated in FIGS. 1 and 4;

FIG. 6 is a top plan view of the portable hand held electronic terminal (e.g., key fob) illustrated in FIGS. 1, 4 and 5;

FIG. 7 is a bottom plan view of the portable hand held electronic terminal (e.g., key fob) illustrated in FIGS. 1, 4, 5 and 6;

FIG. 8 is a simplified schematic view of selected component of the portable hand held electronic terminal (e.g., key fob) illustrated in FIGS. 1 and 4 to 7; and

FIG. 9 is a perspective view of a remote vehicle operating system having a vehicle and a portable hand held electronic terminal in accordance with another embodiment.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

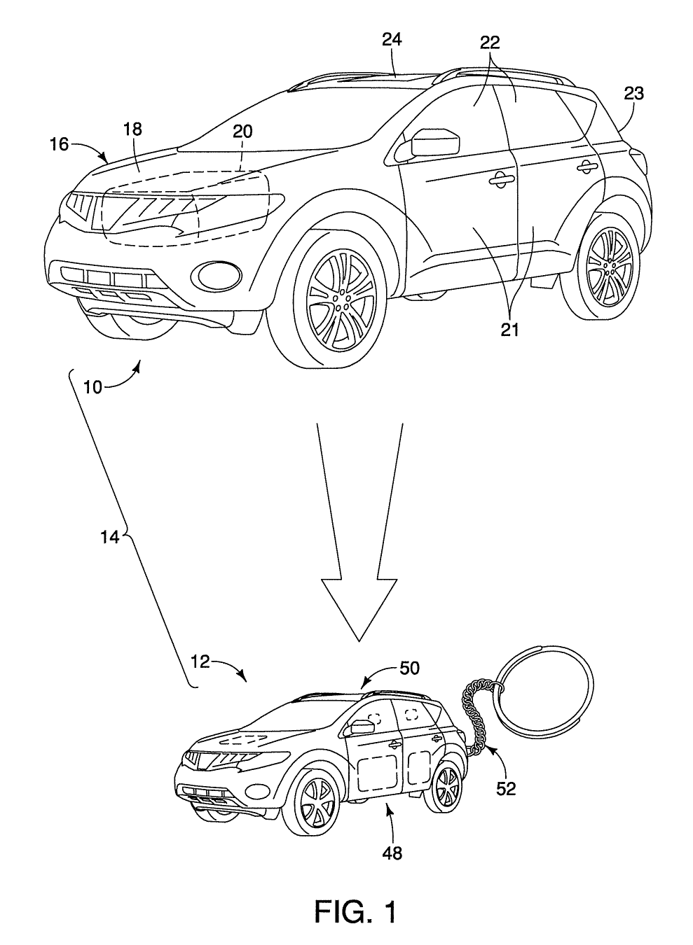

Referring initially to FIG. 1, an actual vehicle 10 is illustrated that is remotely controlled by a portable hand held electronic terminal 12 (e.g., a key fob) in accordance with a first embodiment. Preferably, the basic functions of the portable hand held electronic terminal 12 are carried out in a similar manner as currently available key fobs such as the intelligent-key that is sold with Nissan vehicles. Thus, the vehicle 10 and the portable hand held electronic terminal 12 constitutes a remote vehicle operating system 14. The vehicle 10 is a sport utility vehicle (SUV). However, the vehicle 10 can be any type of vehicle with different features as needed and/or desired. The portable hand held electronic terminal 12 has a vehicle shaped configuration. Basically, the portable hand held electronic terminal 12 remotely and wirelessly controls various vehicle operations, such as starting the vehicle 10, locking and unlocking the vehicle 10, etc., by touching a part of the portable hand held electronic terminal 12 that basically corresponds to the part of the vehicle 10 that is to be operated, as explained below.

In the illustrated embodiment, the portable hand held electronic terminal 12 is shaped as a miniature replica of the vehicle 10. In other words, the overall look of the portable hand held electronic terminal 12 is the same as the vehicle 10, but for size and details. For example, the vehicle 10 is illustrated as a Nissan Murano and the portable hand held electronic terminal 12 is shaped as a miniature Nissan Murano. However, the miniature Nissan Murano of the portable hand held electronic terminal 12 is not necessarily an exact scale model of the actual vehicle. In other words, some dimensions can be modified (stretched/enlarged) to accentuate appeal of the “miniature replica” model and/or accommodate buttons, electrical components and the like. Thus, the phrase “miniature replica vehicle” as used herein refers to a vehicle body shape that basically corresponds in make and model to the vehicle exterior body of the actual vehicle, but is reduced in size with respect to the vehicle exterior body of the actual vehicle and can be either to scale or not to scale. On the other hand, the phrase “general appearance” as used herein to describe the similarity of the portable hand held electronic terminal 12 to the actual vehicle 10 refers to the overall body shape of the portable hand held electronic terminal 12 being similar in body type to the actual vehicle 10. For example, the portable hand held electronic terminal 12 and the actual vehicle 10 has the same general appearance if they are both SUV's, or if they are both sedans, or if they are both coupes, but could be different makes and/or models.

Alternatively, the portable hand held electronic terminal 12 can just be a miniature vehicle, which does not necessarily match the overall shape or body type (e.g., type—sedan, coupe, SUV, etc.) of the vehicle 10. For example, the miniature vehicle of the portable hand held electronic terminal 12 could correspond to a person's favorite NASCAR driver's car, while their actual car could be a totally different make, model and body type. In any event, the portable hand held electronic terminal 12 has a miniature vehicle shaped configuration.

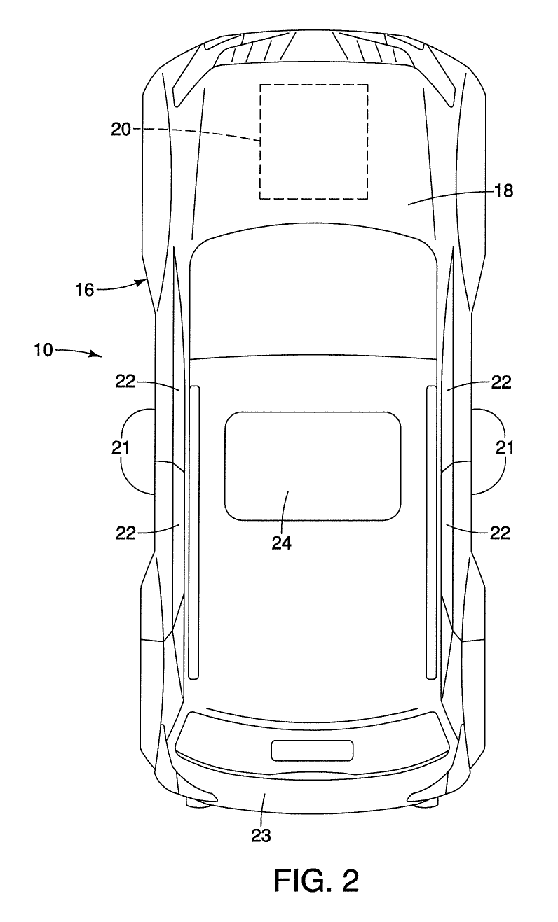

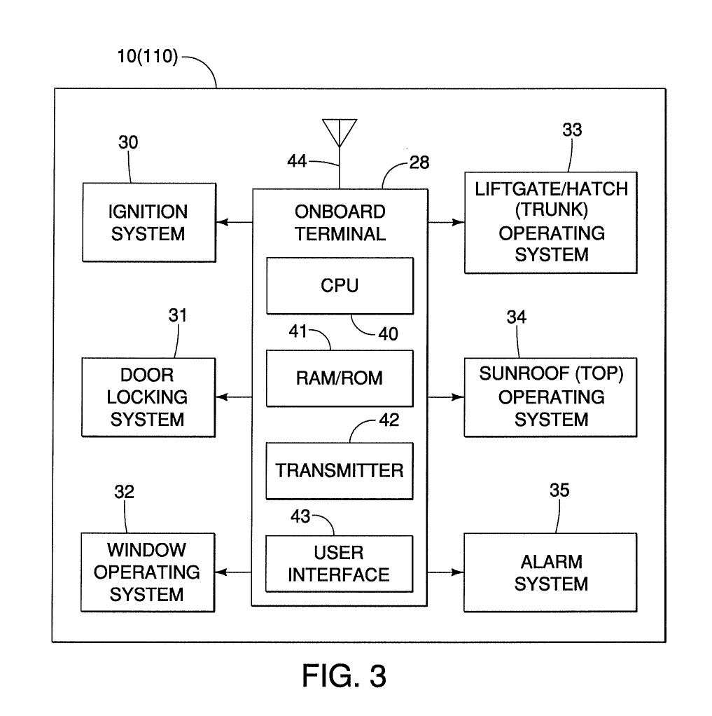

Generally speaking, as seen in FIG. 1 and 2, the actual vehicle 10 includes among other things, a vehicle exterior body 16 having a hood 18 covering an engine or electric motor 20, a plurality of doors 21, a plurality of moving windows 22, a rear liftgate/hatch 23 and a sunroof 24. As seen in FIG. 3, the vehicle 10 further includes an onboard terminal 28, an ignition system 30, a door locking system 31, a window operating system 32, a rear liftgate/hatch operating system 33, a sunroof operating system 34 and an alarm system 35. The systems 30 to 35 are onboard devices that are operatively connected to the onboard terminal 28. Thus, the onboard terminal 28 is configured to perform a selected operation of a vehicle component of one of these systems 30 to 35 in response to a command signal from the portable hand held electronic terminal 12.

The onboard terminal 28 is preferably on board unit that basically includes a microcomputer or central processing unit (CPU) 40, a storage component 41 such as a ROM (Read Only Memory) and a RAM (Random Access Memory), a wireless two communication device or transmitter 42 and a user interface 43. The storage component 41 includes a various control program that at least controls the systems 30 to 35. The onboard terminal 28 also includes other conventional components, such as an input interface circuit, an output interface circuit, etc., that are typically associated with keyless entry systems. The transmitter 42 has an antenna 44 for sending and receiving command signals. The onboard terminals for keyless entry systems are conventional components that are well known in the art. Since onboard terminals for keyless entry systems are well known in the art, the structures associated with the onboard terminal 28 will not be discussed or illustrated in detail herein. Rather, it will be apparent to those skilled in the art from this disclosure that the components can be any type of structure and/or programming that can be used to carry out the present invention.

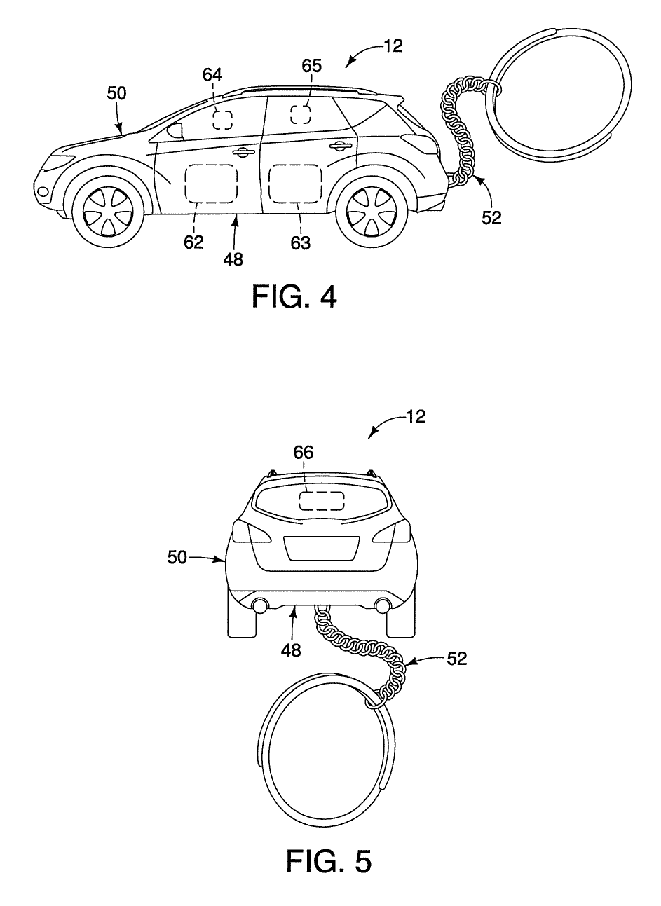

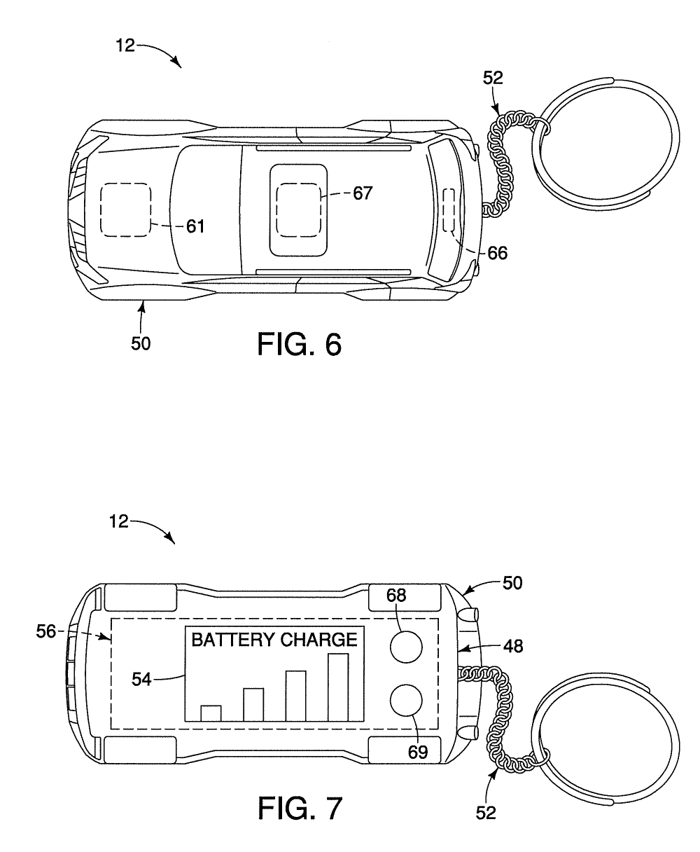

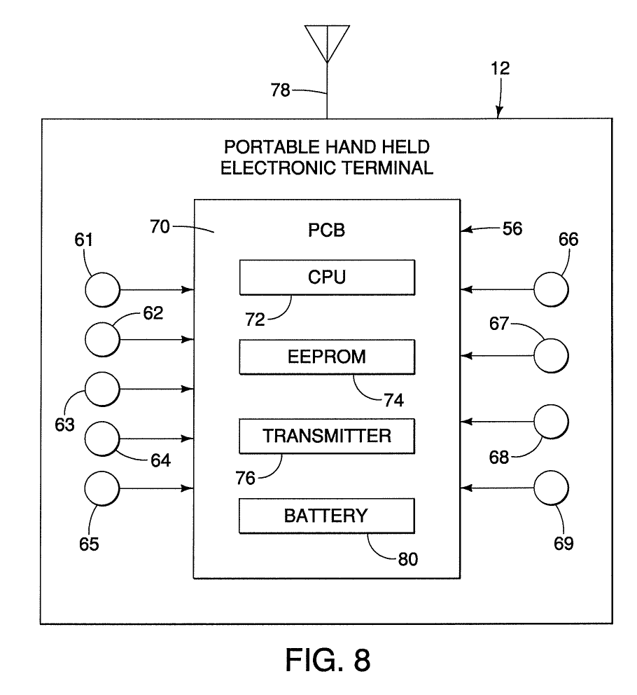

As seen in FIGS. 4 to 8, the portable hand held electronic terminal 12 includes an electronic supporting portion 48, a miniature vehicle shaped casing 50, a key chain 52, a display 54 and a controller module 56. The electronic supporting portion 48 supports the casing 50. Thus, the casing 50 covers an upper portion of the electronic supporting portion 48 such that the bottom surface of the electronic supporting portion 48 is exposed. The wheels of the portable hand held electronic terminal 12 are preferably attached to the electronic supporting portion 48. The key chain 52 is attached to the electronic supporting portion 48 at the rear end of the casing 50. As best seen in FIG. 7, the display 54 is mounted to the electronic supporting portion 48 so as to be visible from the bottom of the electronic supporting portion 48.

The miniature vehicle shaped casing 50 is can be constructed in several different ways. For example, the miniature vehicle shaped casing 50 can be a soft flexible skin that covers the electronic supporting portion 48, or can be a hard rigid member with a plurality of button openings. In any case, the miniature vehicle shaped casing 50 is shaped as a miniature vehicle and more preferably shaped as a miniature replica of the actual vehicle 10 as seen in FIG. 1.

The portable hand held electronic terminal 12 further includes a plurality of switches or buttons 61 to 69 for transmitting a command signal to the onboard terminal 28 of the actual vehicle 10. The buttons 61 to 67 constitute operating elements that are disposed in positions of the miniature vehicle shaped casing 50 such that touching a miniature vehicle component (e.g. a miniature door) of the miniature vehicle shaped casing 50 results in operation of the corresponding one of the vehicle components of the actual vehicle 10. Depending on the construction of the miniature vehicle shaped casing 50, the buttons 61 to 67 can be beneath the casing 50 or can be located in button openings in the casing 50. For the sake of simplicity, the buttons 61 to 67 are depicted beneath the casing 50. The buttons 68 and 69, on the other hand, are operating elements that are depicted as projecting out of openings in the bottom surface of the electronic supporting portion 48.

In the illustrated embodiment, the button 61 of the portable hand held electronic terminal 12 is an operating element that is disposed in a position of a miniature hood of the miniature vehicle shaped casing 50. When the user touches the miniature hood of the miniature vehicle shaped casing 50 with a sufficient force to depress the button 61, the controller module 56 sends a signal to the onboard terminal 28. The onboard terminal 28 then activates the ignition system 30 to start the engine or electric motor 20 of the vehicle 10.

In the illustrated embodiment, the button 62 of the portable hand held electronic terminal 12 is an operating element that is disposed in a position of a miniature door (driver's side front door) of the miniature vehicle shaped casing 50. When the user touches the miniature door (driver's side front door) of the miniature vehicle shaped casing 50 with a sufficient force to depress the button 62, the controller module 56 sends a signal to the onboard terminal 28. The onboard terminal 28 then activates the door locking system 31 to lock the doors 21 of the vehicle 10.

In the illustrated embodiment, the button 63 of the portable hand held electronic terminal 12 is an operating element that is disposed in a position of a miniature door (driver's side rear door) of the miniature vehicle shaped casing 50. When the user touches the miniature door (driver's side rear door) of the miniature vehicle shaped casing 50 with a sufficient force to depress the button 63, the controller module 56 sends a signal to the onboard terminal 28. The onboard terminal 28 then activates the door locking system 31 to unlock the doors 21 of the vehicle 10.

In the illustrated embodiment, the button 64 of the portable hand held electronic terminal 12 is an operating element that is disposed in a position of a miniature window (driver's side front window) of the miniature vehicle shaped casing 50. When the user touches the miniature window (driver's side front window) of the miniature vehicle shaped casing 50 with a sufficient force to depress the button 64, the controller module 56 sends a signal to the onboard terminal 28. The onboard terminal 28 then activates the window operating system 32 to close the windows 22 of the vehicle 10.

In the illustrated embodiment, the button 65 of the portable hand held electronic terminal 12 is an operating element that is disposed in a position of a miniature window (driver's side rear window) of the miniature vehicle shaped casing 50. When the user touches the miniature window (driver's side rear window) of the miniature vehicle shaped casing 50 with a sufficient force to depress the button 65, the controller module 56 sends a signal to the onboard terminal 28. The onboard terminal 28 then activates the window operating system 32 to open the windows 22 of the vehicle 10.

In the illustrated embodiment, the button 66 of the portable hand held electronic terminal 12 is an operating element that is disposed in a position of a miniature rear liftgate/hatch of the miniature vehicle shaped casing 50. When the user touches the miniature rear liftgate/hatch of the miniature vehicle shaped casing 50 with a sufficient force to depress the button 66, the controller module 56 sends a signal to the onboard terminal 28. The onboard terminal 28 then activates the rear liftgate/hatch operating system 33 to unlock and open the rear liftgate/hatch 23 of the vehicle 10.

In the illustrated embodiment, the button 67 of the portable hand held electronic terminal 12 is an operating element that is disposed in a position of a miniature sunroof of the miniature vehicle shaped casing 50. When the user touches the miniature sunroof of the miniature vehicle shaped casing 50 with a sufficient force to depress the button 67, the controller module 56 sends a signal to the onboard terminal 28. The onboard terminal 28 then activates the sunroof operating system 34 to open the sunroof 24 of the vehicle 10 if the sunroof is closed and to close the sunroof 24 of the vehicle 10 if the sunroof is open.

In the illustrated embodiment, the buttons 68 and 69 of the portable hand held electronic terminal 12 are operating elements that are disposed on the bottom surface of the electronic supporting portion 48. In particular, the buttons 68 and 69 project out of openings in the bottom surface of the electronic supporting portion 48. The button 68 is used for operating the alarm system 35 of the vehicle 10 in the case of an emergency. When the user depresses the button 68, the controller module 56 sends a signal to the onboard terminal 28. The onboard terminal 28 then activates the alarm system of the vehicle 10. The button 69 is a programmable button in which the user can program the button 69 to operate anyone of the systems 30 to 34 or some other system (not shown) of the vehicle 10, as need and/or desired.

The controller module 56 basically includes a printed circuit board 70 that has a microprocessor (CPU) 72, memory (EEPROM) 74, a transmitter 76 with an antenna 78 and a battery 80. The controller module 56 executes wireless communication with the onboard terminal 28 through the transmitter 76 and the antenna 78. The memory (EEPROM) 74 is nonvolatile memory that stores ID (Identification Data) codes for identifying a person having the portable hand held electronic terminal 12 as a permitted driver. The battery 23 is an exchangeable battery that supplies electric power to the other components of the controller module 56. The microprocessor 72 is connected to each of the switches or buttons 61 to 69 such that depressing the buttons 61 to 69 result in a command signal to be sent via the transmitter 76 and the antenna 78 to the onboard terminal 28. Since key fobs with controller modules are well known in the art, the controller module 56 will not be discussed in further detail.

Preferably, the transmitter 76 is a two way transmitter that can receive signals from the onboard terminal 28. Thus, in the case of the vehicle 10 being an electric vehicle or a hybrid vehicle, the transmitter 76 can receive a signal indicative of a state of charge of the vehicle battery. The microprocessor 72 will then display the state of charge of the battery on the display 54. The display 54 can be an LCD display that is activated upon pressing one of the buttons 61 to 69 or when the portable hand held electronic terminal 12 is within a prescribed distance from the vehicle 10. Of course, the display 54 can be used to display other vehicle information with respect to a vehicle component of the vehicle 10 as needed and/or desired.

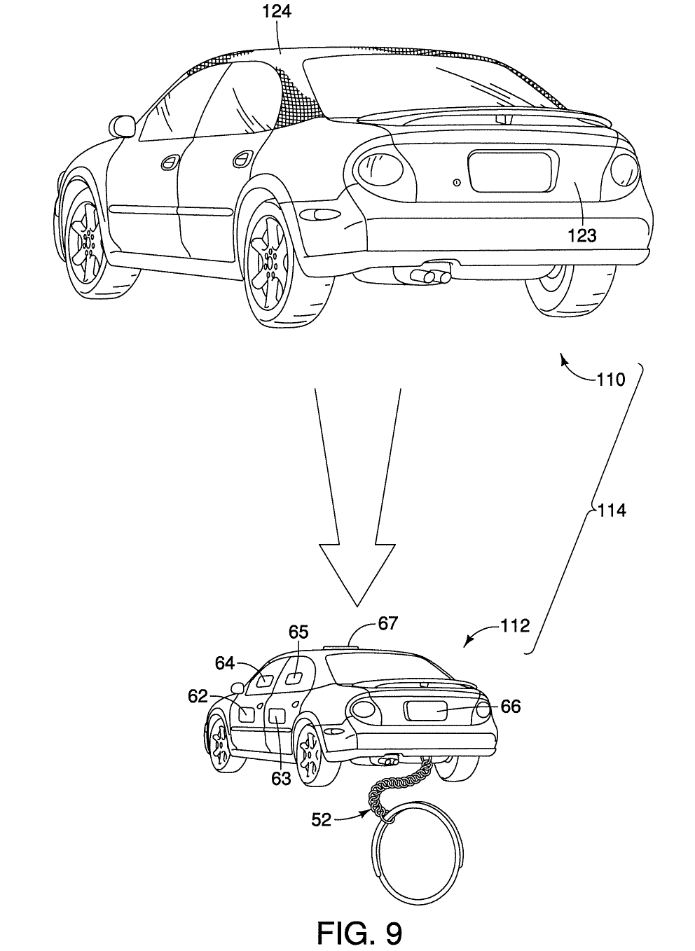

Referring now to FIG. 9, another actual vehicle 110 is illustrated that is remotely controlled by another portable hand held electronic terminal 112. The vehicle 110 and the portable hand held electronic terminal 112 constitutes a remote vehicle operating system 114. The vehicle 110 is a four door sedan with a convertible top. However, the vehicle 110 can be any type of vehicle with different features as needed and/or desired. The portable hand held electronic terminal 112 has a vehicle shaped configuration. Basically, the portable hand held electronic terminal 112 remotely and wirelessly controls various vehicle operations, such as starting the vehicle 110, locking and unlocking the vehicle 110, etc., by touching a part of the portable hand held electronic terminal 112 that basically corresponds to the part of the vehicle 110 that is to be operated, as explained below.

The actual vehicle 110 includes the onboard terminal 28 and systems 30 to 35 as seen in FIG. 3. The portable hand held electronic terminal 112 includes the electronic supporting portion 48, the key chain 52, the display 54, the controller module 56 and the switches or buttons 61 to 69 of the first embodiment. The portable hand held electronic terminal 112 also has the switches or buttons 61 to 69 of the first embodiment for transmitting a command signal to the onboard terminal 28 of the actual vehicle 110. The portable hand held electronic terminal 112 is identical to the portable hand held electronic terminal 12, discussed above, except that the portable hand held electronic terminal 112 has a miniature vehicle shaped casing 150 in the form of a convertible sedan and the buttons 66 and 67 operate a rear trunk 123 of the actual vehicle 110 and a convertible top 124 of the actual vehicle 110, respectively.

In this embodiment, the buttons 61 to 67 are disposed in button openings of the miniature vehicle shaped casing 150. The buttons 61 to 67 are substantially flush or slightly raised with respect to the outer surface of the miniature vehicle shaped casing 150. The buttons 61 to 65, 68 and 69 function in the same way as discussed above with respect to the first embodiment.

In the illustrated embodiment, the button 66 of the portable hand held electronic terminal 112 is an operating element that is disposed in a position of a miniature rear trunk of the miniature vehicle shaped casing 150. When the user touches the miniature rear trunk of the miniature vehicle shaped casing 150 with a sufficient force to depress the button 66, the controller module 56 sends a signal to the onboard terminal 28. The onboard terminal 28 then activates a truck operating system to unlock and open the rear trunk 123 of the vehicle 10.

In the illustrated embodiment, the button 67 of the portable hand held electronic terminal 12 is an operating element that is disposed in a position of a miniature convertible top of the miniature vehicle shaped casing 150. When the user touches the miniature convertible top of the miniature vehicle shaped casing 150 with a sufficient force to depress the button 67, the controller module 56 sends a signal to the onboard terminal 28. The onboard terminal 28 then activates a top operating system to open the convertible top 124 of the vehicle 110 if the convertible top 124 is closed and to close the convertible top 124 of the vehicle 110 if the sunroof is open.

Of course, other parts of the vehicle 110 can be operated by providing additional buttons and/or programming the buttons 61 to 69 to perform other functions as need and/or desired. For example, a button could be place in the area defining the miniature front windshield such that depressing this button activates a defroster or the like.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A remote vehicle operating system comprising:
a vehicle including a vehicle exterior body, an onboard terminal and at least one onboard device operatively connected to the onboard terminal; and
a portable hand held electronic terminal including a miniature vehicle shaped casing corresponding in general appearance to the vehicle exterior body of the vehicle, but reduced in size with respect to the vehicle exterior body of the vehicle,
the portable hand held electronic terminal further including a transmitter disposed in the miniature vehicle shaped casing that communicates with the onboard terminal of the vehicle to transmit a command to the onboard device.

2. The remote vehicle operating system according to claim 1, wherein
the onboard device is operatively connected to the onboard terminal to perform a selected operation of a vehicle component; and
the portable hand held electronic terminal further includes an operating element disposed in a position of the miniature vehicle shaped casing such that touching a miniature vehicle component of the portable hand held electronic terminal corresponding to the vehicle component of the vehicle results in the operation of the vehicle component.

3. The remote vehicle operating system according to claim 2, wherein
the vehicle component of the vehicle is a door and the miniature vehicle component is a miniature door such that touching the miniature door results in either locking or unlocking the door of the vehicle.

4. The remote vehicle operating system according to claim 2, wherein
the vehicle component of the vehicle is a trunk and the miniature vehicle component is a miniature trunk such that touching the miniature trunk results in opening the trunk of the vehicle.

5. The remote vehicle operating system according to claim 2, wherein
the vehicle component of the vehicle is a sunroof and the miniature vehicle component is a miniature sunroof such that touching the miniature sunroof results in opening the sunroof of the vehicle.

6. The remote vehicle operating system according to claim 2, wherein
the vehicle component of the vehicle is a window and the miniature vehicle component is a miniature window such that touching the miniature window results in opening the window of the vehicle.

7. The remote vehicle operating system according to claim 2, wherein
the vehicle component of the vehicle is a convertible top and the miniature vehicle component is a miniature convertible top such that touching the miniature convertible top results in opening the convertible top of the vehicle.

8. The remote vehicle operating system according to claim 2, wherein
the vehicle component of the vehicle is a rear liftgate/hatch and the miniature vehicle component is a miniature rear liftgate/hatch such that touching the miniature rear liftgate/hatch results in opening the rear liftgate/hatch of the vehicle.

9. The remote vehicle operating system according to claim 1, wherein
the onboard device is operatively connected to the onboard terminal to start the vehicle; and
the portable hand held electronic terminal further includes an operating element disposed in a position of a miniature hood of the portable hand held electronic terminal such that touching the miniature hood starts the vehicle.

10. The remote vehicle operating system according to claim 1, wherein
the portable hand held electronic terminal further includes a display for display information with respect to a vehicle component of the vehicle.

11. The remote vehicle operating system according to claim 10, wherein
the vehicle further includes a battery operatively connected to the onboard terminal, and the display of the portable hand held electronic terminal is configured to display a state of charge of the battery upon receiving a signal from the onboard terminal that is indicative of the state of charge of the battery.

12. The remote vehicle operating system according to claim 1, wherein
the portable hand held electronic terminal further includes at least one button to operate the onboard device the vehicle.

13. The remote vehicle operating system according to claim 12, wherein
the button on a bottom side of the miniature vehicle shaped casing that corresponds to an underside of the vehicle.

14. A remote vehicle operating system comprising:
a vehicle including a vehicle exterior body, an onboard terminal and at least one onboard device operatively connected to the onboard terminal to perform a selected operation of a vehicle component; and
a portable hand held electronic terminal including a miniature vehicle shaped casing,
the portable hand held electronic terminal further including a transmitter disposed in the miniature vehicle shaped casing that communicates with the onboard terminal of the vehicle to transmit a command to the onboard device,
the portable hand held electronic terminal further including an operating element disposed in a position of the miniature vehicle shaped casing such that touching a miniature vehicle component corresponding to the vehicle component of the vehicle results in the operation of the vehicle component.

15. The remote vehicle operating system according to claim 14, wherein
the vehicle component of the vehicle is a door and the miniature vehicle component is a miniature door such that touching the miniature door results in either locking or unlocking the door of the vehicle.

16. The remote vehicle operating system according to claim 14, wherein
the vehicle component of the vehicle is a trunk and the miniature vehicle component is a miniature trunk such that touching the miniature trunk results in opening the trunk of the vehicle.

17. The remote vehicle operating system according to claim 14, wherein
the vehicle component of the vehicle is a sunroof and the miniature vehicle component is a miniature sunroof such that touching the miniature sunroof results in opening the sunroof of the vehicle.

18. The remote vehicle operating system according to claim 14, wherein
the vehicle component of the vehicle is a window and the miniature vehicle component is a miniature window such that touching the miniature window results in opening the window of the vehicle.

19. The remote vehicle operating system according to claim 14, wherein
the vehicle component of the vehicle is a convertible top and the miniature vehicle component is a miniature convertible top such that touching the miniature convertible top results in opening the convertible top of the vehicle.

20. The remote vehicle operating system according to claim 14, wherein
the vehicle component of the vehicle is a rear liftgate/hatch and the miniature vehicle component is a miniature rear liftgate/hatch such that touching the miniature rear liftgate/hatch results in opening the rear liftgate/hatch of the vehicle.

21. The remote vehicle operating system according to claim 14, wherein
the onboard device is operatively connected to the onboard terminal to start the vehicle; and
the portable hand held electronic terminal further includes an operating element disposed in a position of a miniature hood of the miniature vehicle shaped casing such that touching the miniature hood of the miniature vehicle shaped casing starts the vehicle.

22. The remote vehicle operating system according to claim 14, wherein
the portable hand held electronic terminal further includes a display for display information with respect to a vehicle component of the vehicle.

23. The remote vehicle operating system according to claim 22, wherein
the vehicle further includes a battery operatively connected to the onboard terminal, and the display of the portable hand held electronic terminal is configured to display a state of charge of the battery upon receiving a signal from the onboard terminal that is indicative of the state of charge of the battery.

24. The remote vehicle operating system according to claim 1, wherein
the portable hand held electronic terminal further includes at least one button to operate the onboard device the vehicle.

25. The remote vehicle operating system according to claim 12, wherein
the button on a bottom side of the miniature vehicle shaped casing that corresponds to an underside of the vehicle.

26. A portable hand held electronic terminal comprising:
a miniature vehicle shaped casing;
a transmitter disposed in the miniature vehicle shaped casing that communicates with a onboard terminal of a vehicle to transmit a command to an onboard device; and
an operating element disposed in a position of the miniature vehicle shaped casing such that touching a miniature vehicle component corresponding to a vehicle component of the vehicle results in operation of the vehicle component.

27. The portable hand held electronic terminal according to claim 26, wherein
the miniature vehicle component is a miniature door such that touching the miniature door results in either locking or unlocking a door of the vehicle.

28. The portable hand held electronic terminal according to claim 26, wherein
the miniature vehicle component is a miniature trunk such that touching the miniature trunk results in opening a trunk of the vehicle.

29. The portable hand held electronic terminal according to claim 26, wherein
the miniature vehicle component is a miniature sunroof such that touching the miniature sunroof results in opening a sunroof of the vehicle.

30. The portable hand held electronic terminal according to claim 26, wherein
the vehicle component of the vehicle is a window and the miniature vehicle component is a miniature window such that touching the miniature window results in opening the window of the vehicle.

31. The portable hand held electronic terminal according to claim 26, wherein
the vehicle component of the vehicle is a convertible top and the miniature vehicle component is a miniature convertible top such that touching the miniature convertible top results in opening the convertible top of the vehicle.

32. The portable hand held electronic terminal according to claim 26, wherein
the vehicle component of the vehicle is a rear liftgate/hatch and the miniature vehicle component is a miniature rear liftgate/hatch such that touching the miniature rear liftgate/hatch results in opening the rear liftgate/hatch of the vehicle.

33. The portable hand held electronic terminal according to claim 26, wherein
the onboard device is operatively connected to the onboard terminal to start the vehicle; and
the portable hand held electronic terminal further includes an operating element disposed in a position of a miniature hood of the miniature vehicle shaped casing such that touching the miniature hood of the miniature vehicle shaped casing starts the vehicle.

34. The portable hand held electronic terminal according to claim 26, wherein
the portable hand held electronic terminal further includes a display for display information with respect to a vehicle component of the vehicle.

35. The portable hand held electronic terminal according to claim 26, wherein
the portable hand held electronic terminal further includes at least one button to operate the onboard device the vehicle.

36. The portable hand held electronic terminal according to claim 35, wherein
the button on a bottom side of the miniature vehicle shaped casing that corresponds to an underside of the vehicle.
